(19) United States
(12) Patent Application Publication
(10) Pub. No.: US 2006/0278088 A1
(43) Pub. Date: Dec. 14, 2006

(54) Vacuum apparatus and method using ultraviolet radiation for sanitization

(76) Inventor: Darin R. Helsel, Wichita, KS (US)

Correspondence Address: Bradley P. Sylvester, Suite 300, 200 North Broadway, Wichita, KS, 67202, US

(21) Appl. No.: 11/149,104

(22) Filed: Jun. 10, 2005

(51) Int. Cl. B01D 46/00

(52) U.S. Cl. 96/224

(57) ABSTRACT

This invention deals specifically with the use of ultraviolet light emitters within a vacuum cleaner, where the lights are used to neutralize bacterial contamination. The air and debris entering into the vacuum is exposed to one or more ultraviolet light sources, with the resulting radiation causing the bacterial contaminants to be neutralized. The vacuum used may be an upright bag vacuum, an upright bagless vacuum, a floor type vacuum, or a shop type vacuum. Multiple chambers are provided, in which the lights are disposed in secondary chambers, in addition to any lights used at the point of initial filtration.

### BACKGROUND OF THE INVENTION

Previous inventions have recognized the usefulness of ultraviolet light radiation for sanitization purposes. Numerous uses have been recognized for the treatment of objects and air volumes. Ultraviolet light has been used to sterilize objects and air masses within buildings. The treatment of air with ultraviolet light within a building air duct is an attempt to cure the problem of airborne bacteria after it has already entered into an airmass. The term “bacteria” should be understood to be illustrative of any type of biological contaminant that is able to be neutralized or killed through exposure to ultraviolet light radiation. Household vacuum cleaners generally have the most opportunity and propensity of any appliance to move bacteria from the floor or carpet back into the air, as a result of inadequate filtering techniques. The treatment of the airflow through the vacuum cleaner itself is of primary importance in achieving proper sanitation. While prior art shows a desire to treat objects and air, the techniques have not been provided suitably for household vacuum cleaners.

Referring now to U.S. Pat. No. 4,973,847 (1990, Lackey et al.), a sanitizing device for toothbrushes is shown, in which an ultraviolet light source is provided to being close proximity with the toothbrush heads, so as to destroy bacteria while the toothbrushes are being stored. This invention examples the recognized need and usefulness for ultraviolet light use in sterilization, but is applicable to stationary objects.

The use of ultraviolet light in stationary room air filters is well recognized. In U.S. Pat. No. 5,330,722 (1994, Pick et al.) a germicidal air filter is shown and disclosed. An air filtration media and an ultraviolet light source are utilized in conjunction, so as to take circulating air and expose it to an ultraviolet light and filter to remove particles and destroy airborne bacteria.

In U.S. Pat. No. 5,505,904 (1996, Haidinger et al.), an air disinfection method and unit are shown. In this invention, the unit is capable of being placed within a building, so that recirculated air passes over UV-C lamps which effectively neutralize unwanted bacteria. The unit and method shown, include an enclosure through which the air is passed. There is no mobility or portability associated with this particular invention. This invention, like the others discussed, are useful only in treating air in a room or enclosure, and not for treating air during a vacuuming process.

U.S. Pat. No. 5,453,049 (1995, Tillman, Jr. Et al.) examples a corner air filtration unit, in which the concept of placing a germicidal ultraviolet radiation lamp is shown and claimed. The light source is considered to be an additional method of air purification. This particular apparatus and method is restricted to a single stationery unit. Similarly, U.S. Pat. No. 5,833,740 (1998, Brais) discloses a stationary air purifier, which also includes an ultraviolet light placed along the length of the tubing, also referred to as the housing, through which the airflow occurs.

U.S. Pat. No. 5,902,552 (1999, Brickley), considers and discusses the benefits of placing ultraviolet lamps inside an air duct system, whereby the stationery air recirculating system is subjected to ultraviolet radiation when it is passing through the air duct system. This invention only treats air moving through an air recirculation system, but does not prevent the introduction of airborne bacteria in the first place when using a vacuum sweeper.

Another example of treating the problem of bacteria is shown in U.S. Pat. No. 6,365,113 (2002, Roberts), which discloses a trash receptacle that uses a UV light source in part, to help sterilize bacteria present within it, and examples the concept of treating bacteria in a stationary environment, without rapid air flow.

U.S. Pat. No. 6,464,760 (2002, Sham), discloses an ultraviolet air purifier, which utilizes a filter system and ultraviolet means, with a safety circuit to protect the user from accidental exposure to ultraviolet light. This invention also deals with air that already has bacteria present in it, and is not a means to prevent the movement of bacteria from a stationary floor surface to an airborne status.

US patent application number US 2003/0030015 (publication date Feb. 13, 2003) discloses a drawer like assembly, which allows items to be specifically irradiated using ultraviolet light when placed on the drawer tray and slid into the main body of the apparatus. This invention allows for stationary treatment of an article or area, but is not conducive with high airflow rates.

U.S. Pat. No. 6,589,486 (2003, Spanton), discloses an air cleaning apparatus using ultraviolet light, that a usable with an HVAC system having a metal airflow duct. The placement of the radiation source is within the ductwork, and would not be transferable into a vacuum cleaner. This invention again deals with air that already has bacteria present in it, and is not a means to prevent the movement of bacteria from a stationary floor surface to an airborne status.

U.S. Pat. No. 6,679,419 (2004, Sarracino) discloses an improved mailbox that utilizes ultraviolet light used to radiate the interior of said mailbox when it is closed, further exampling the concept of stationary air and article treatment for bacteria.

U.S. Pat. No. 6,680,028 (2004, Harris), discloses a portable air purification system, however this air purifier is similar to the stand alone or non mobile systems previously seen, with the ultraviolet radiation means included to protect and prevent bacterial growth on the filter pack. It only treats bacteria presently in the air, and does not treat bacteria in the carpet as it moves through a vacuum cleaner.

U.S. Pat. No. 6,779,714 (2004, Webb) discloses another mailbox, in which ultraviolet light is used to you radiate the mailbox, with a predetermined delay timer that allows sufficient time for their radiation to take complete and desired effect.

U.S. Pat. No. 6,818,117 (2004, Turcotte) discloses an ultraviolet air purification system, that is adapted to numerous types of air handling systems in buildings. A duct system is required, and this patent is intended to either upgrade or allow for installation of this invention. This invention would assist in treating airborne bacteria, but would not prevent the bacteria from being lifted from the floor into the air during the vacuuming process, nor treat bacteria until it is already in the air mass of the building.

It is clear that the treatment of bacteria infected air, as it moves through a vacuum cleaner is an advantage over prior art in irradiating bacteria, since the method and apparatus of treating air within a vacuum cleaner treats the bacteria before it has a chance to be breathed or spread about an airspace.

### SUMMARY OF THE INVENTION

This invention is directed to an improved mobile vacuum cleaner, which includes a UV radiation light source in addition to any existing filter means, to remove or eliminate bacteria and undesirable biological contaminants. The term “bacteria” should be understood to be illustrative of any type of biological contaminant that is able to be neutralized or killed through exposure to ultraviolet light radiation. Vacuum cleaners have the general intent and purpose of lifting and removing debris off of a floor area. Other uses, although not as commonly associated with vacuum cleaners, include the removal of dust and lint from vertical surfaces or fabrics such as drapes or furniture.

Vacuum cleaners comprise several various design features that are common to virtually all vacuums. An intake port is provided, through which air rushes in due to the fact that the air pressure further up inside the vacuum cleaner has been reduced. The air intake is positioned close to the surface which is desired to be swept or have debris removed. The fast moving air stream moving into the vacuum, when placed adjacent to the surface that is being treated, will cause debris and any particulate matter to also move into the air stream and be forced into the vacuum cleaner. Brushes and other physically engaging members may agitate the surface being cleaned to help loosen debris so that it can be carried by the air stream into the vacuum.

The vacuum system considered here comprises what is commonly referred to as an upright vacuum cleaner, a floor model vacuum cleaner, a typical bagless vacuum cleaner, a canister or what is commonly known as a “hop vacuum”, as well as a large industrial vacuum system. All of these vacuums share common features that this present invention is intended to accommodate, and provide bacteriological sterilization. This invention is intended to encompass improvements of ultraviolet light radiation within portable and industrial vacuum cleaners, as a means to further reduce harmful emissions as result of undesired bacteria that is not filtered out during the cleaning process.

Typically, vacuum cleaners have been used to collect particulate matter that is capable of being filtered out of air that is drawn into the vacuum cleaner system. Larger filters have given rise to an increased particular matter removal from the ejected air, but bacteria remains a constant ongoing problem due to its extremely small size. Much of the bacteria that is collected during the vacuuming process has such a small diameter that it is unable to be trapped in conventional filter means. Electronic filters utilizing ionic attraction have met with some success, but on a conventional vacuum cleaner, the filtration system necessary to physically filter out unwanted bacteria is either too cumbersome or too expensive for the average consumer.

This improved method and apparatus is designed to be used with existing vacuum cleaner models and tooled construction mold designs, so as to easily incorporate the use of ultraviolet radiation into the moving air stream within the cleaner. It is also clear that modifications to existing vacuum cleaners may be insufficient, and new designs would be necessary. This invention is intended to take into account both existing and newly modified technology.

A typical upright vacuum cleaner comprises a head unit that has the air intake ports placed closely to the surface being vacuumed. A fan motor will cause air to move through the vacuum cleaner system. The air will first enter through the head unit, into a bag that is contained within a bag chamber, and then exit through a discharge opening. Besides the bag, additional filtration may be utilized. The problem with this typical upright vacuum cleaner is that the filtration methods available must necessarily allow a substantial amount of moving air to pass through the filtration systems within it. Even though the filtration surface area may be substantial, such as the surface area of the filter/collection bag, great deal of bacteria is able to pass through this type filtration.

One of the main problems with allowing bacteria to escape a vacuum cleaner, is that previously benign or stationary bacteria on a floor or carpet, becomes airborne once it is ejected through the discharge opening. The bacteria may then have an opportunity to remain airborne for some time, and breathed into a person's respiratory system. Therefore, typical vacuuming can dramatically increase the amount of airborne bacteria.

The typical upright has a first chamber in which the bag is situated. Ultraviolet lights may be placed within the chamber around the bag, so that the ultraviolet radiation contacts the outer surface of the bag at a sufficient level and intensity so as to irradiate most or all of the bacteria moving through the bag filter. In an improved upright vacuum cleaner, a secondary chamber is provided, which allows the air that has been previously filtered to move into the second chamber prior to being discharged. The second chamber may have one or more ultraviolet light sources, which provide a sufficient amount of ultra violent radiation within the second chamber to successfully eliminate living bacterial matter. Ultraviolet light sources may be present in an improved vacuum cleaner in both the first chamber, the second chamber, or both chambers concurrently.

Bagless upright vacuum cleaners have become quite popular, due to their ease for collected debris removal, as well as the attractive filtration systems that they use, such as the HEPA filtration system that removes extremely small particles. However, even the HEPA filtration system exhibits an inability to collect all bacterial matter during the final filtration process.

The bagless upright vacuum often has a collector, which is generally a tubular member with a closed bottom, that allows air and debris to swirl within this collector, with the heavier debris falling to the bottom of the collector. When most of the debris has fallen out of the air stream, the remaining air stream is generally pushed through a filter means. The ultraviolet light source may be placed within the collector itself, so that all of the debris and moving air stream is effectively sterilized using ultraviolet light. In this manner, both the air stream, and the collected debris, are both treated for bacteria, so that even when the collector is emptied, there will be a significant reduction of bacteria in the dust and debris dumped out into another trash receptacle. This is extremely beneficial, since the dumping process of the collector often results in some dusting and proliferation of small particles back into the air. A post or secondary chamber with ultraviolet light source or sources may also be used alone or in combination with the light sources noted above.

Floor vacuum cleaners are those type of vacuum cleaners that have a canister on wheels that is capable of following a user as they move the collection head unit, with the head unit being connected to the canister through a suction tube. These type of vacuum cleaners may have a bag for the collection and retention of debris, and may also have a secondary filter system between the bag and the discharge opening. Other types of floor vacuums may be bagless. Bagless types, such as “shop vac” vacuums, are discussed below. In situations where a floor vacuum is bagless, it may also follow the characteristics of the upright bagless. However, for this particular portion of discussion, the floor vaccum will have a filter bag. Bacterial debris is commonly ejected using this type of apparatus. The placement of ultraviolet light sources in this particular type of vacuum cleaner is accomplished in a manner similar to the typical upright, with the ultraviolet light sources placed within the first chamber, and/or in a second chamber if there is one so provided after a secondary filter means.

The industrial “shop vac” is capable of collecting large amounts of debris and even water. In some ways, this type of vacuum cleaner is similar to the upright bagless version, however most of these types of vacuums have limited filtering capabilities. A collection chamber is provided, which is typically a large bucket on wheels, with a sealing top, where the suction motor is provided. Air enters into top portion of the collection chamber, and swirls around within the collection chamber until it exits through a filtration means, generally located in the top portion of the collection chamber. While the air and debris are swirling within the collection chamber, the heavier debris will settle out of the air, leaving the finer particles remaining to be filtered out. These type of vacuum cleaning systems often have the worst filtration. Since their use is primarily to pick up large volumes of material, the emphasis is on their ability to collect and retain particulate matter, and not to necessarily filter out smaller objects such as bacteria. This improved type of vacuum cleaner will optimally have several ultraviolet light sources placed within the collection chamber, so that the chamber is completely irradiated during the vacuum process. In this manner, the filtration sophistication becomes less relevant to disease prevention, when the bacteria exiting this system have been neutralized through irradiation. The same procedures are available in larger industrial type vacuum systems. In some instances, a secondary chamber may also be provided individually or along with radiation sources located in a precollection chamber, or in the collection area or bag itself. In all instances, ultraviolet lights are able to be placed and are able to contact the air stream moving through the vacuum before it discharges.

Accordingly, it is an object of this invention to provide a portable vacuum cleaner that has the capability of neutralizing and sterilizing biological contaminants such as bacteria through the use of ultraviolet radiation that is provided within the vacuum cleaner with said lights located in and adjacent to the air stream moving through the vacuum cleaner.

It is a further object of this invention to provide an upright vacuum cleaner, having a bag collector means, with the capability of exposing the ejected air and debris to a sufficient amount of ultraviolet radiation so as to sterilize bacteria.

It is a further object of this invention to provide an upright vacuum cleaner, having a bag collector means, with the capability of exposing the outer surface of the bag to a sufficient amount of ultraviolet radiation so as to sterilize bacteria.

It is a further object of this invention to provide an upright “bagless” vacuum cleaner with a means to expose collected debris to a sufficient level of ultraviolet radiation, both as to intensity and to duration, so as to sterilize any bacterial contamination prior to the ejection of any such bacteria from the vacuum cleaner.

It is a further object of this invention to provide a floor vacuum cleaner, having a bag collector means, with the capability of exposing bacteria to a sufficient level of ultraviolet radiation, both as to intensity and to duration, so as to sterilize any bacterial contamination prior to the ejection of any such bacteria from the vacuum cleaner.

It is a further object of this invention to provide a “shop” vacuum cleaner, having a canister collector means, with the capability of exposing bacteria to a sufficient level of ultraviolet radiation, both as to intensity and to duration, prior to the airstream reaching the filter means, so as to sterilize any bacterial contamination prior to the ejection of any such bacteria from the vacuum cleaner.

It is a further object of this invention to provide a “shop vac” vacuum cleaner, having a canister collector means, with the capability of exposing bacteria to a sufficient level of ultraviolet radiation, both as to intensity and to duration, following the movement of the airstream through the filter means, so as to sterilize any bacterial contamination prior to the ejection of any such bacteria from the vacuum cleaner.

It is a further object of this invention to provide an industrial vacuum cleaner, having a canister or tank collector means, with the capability of exposing bacteria to a sufficient level of ultraviolet radiation, both as to intensity and to duration, so as to sterilize any bacterial contamination prior to the ejection of any such bacteria from the vacuum cleaner.

### DESCRIPTION OF THE DRAWINGS

FIG. 1 is a side cross-sectional view of an upright vacuum cleaner having a bag collector means, with a secondary chamber that has been provided with ultraviolet light means.

FIG. 2 is a side cross-sectional view of an upright vacuum cleaner having a bag collector means, in which ultraviolet lighting is provided in the first chamber containing the bag collector means.

FIG. 3 is a cross-sectional view of the vacuum cleaner shown in FIG. 1, as seen from the top portion looking down, showing a cross-sectional view of the first chamber and bag, and the second chamber and multiple ultraviolet light sources.

FIG. 4 is a cross-sectional view of the vacuum cleaner shown in FIG. 2, as seen from the top portion looking down, showing a cross-sectional view of the first chamber and bag and multiple ultraviolet light sources shown oriented about the bag in the first chamber.

FIG. 5 is a cross-sectional side view of a typical floor vacuum, in which this particular vacuum is provided with a bag collector means, and a secondary filter, with ultraviolet light sources positioned both around the bag collector means and post filter area.

FIG. 6 is a perspective view of an upright bagless vacuum cleaner having a removable debris collection canister, with an ultraviolet light source fixed within the collection canister, and an ultraviolet light source placed in a secondary chamber.

FIG. 7 is a perspective view of an upright bagless vacuum cleaner having a removable debris collection canister, with an ultraviolet light source fixed to the main body of the vacuum, and where the collection canister attaches to the upright vacuum cleaner so that the ultraviolet light sources are contained within the removable cannister.

FIG. 8 is a side view of a typical “shop” vacuum, having a bottom canister collection means, and a top portion that houses the motor and air ejection port, with ultraviolet light sources provided in the bottom canister collection means, and also in an ejection side port.

FIG. 9 is a side view of a typical “shop” vacuum, having a bottom canister collection means, and a top housing the motor and ejection port, with ultraviolet light sources provided the ejection side port.

FIG. 10 is a perspective view of an industrial tank unit vacuum cleaner.

FIG. 11 is a cross-sectional side view of the vacuum cleaner shown in FIG. 10, showing a first chamber and secondary chamber separated by a divider, with at least one additional divider that convolutes the air pathway in the second chamber.

FIG. 12 is a side view of the floor vacuum cleaner as also shown in FIG. 5, with the ultraviolet light sources placed within the extension tubing.

FIG. 13 is an enlarged cross-sectional side view of the extension tubing and ultraviolet light source.

### DETAILED DESCRIPTION

Referring to FIG. 1, a typical upright bag vacuum 10 is shown, in which the head 11 is placed adjacent to the surface desired to be vacuumed, so that intake port 8 is adjacent to said surface. All vacuums described herein and below have an intake port, through which air first moves into the vacuum cleaner. The air entering into the vacuum cleaner is generally contaminated with biological matter that can pose a health hazard if breathed or redeposited in the area being vacuumed.

Air enters the intake port 8 and is directed along an air pathway 12 into the collector or bag 13, which traps particulate matter of certain sizes that are present in the air stream 12, as the air stream moves through the lining of the bag 13. As is shown in FIG. 1, the bag 13 is fully contained within a first chamber 14, where said chamber 14 comprises a portion of the interior of the upright canister 15. The bag 13 provides a filter means, whereby air escaping through the porous openings in the bag 13 will move into the area of the first chamber 14 not occupied by the bag 13.

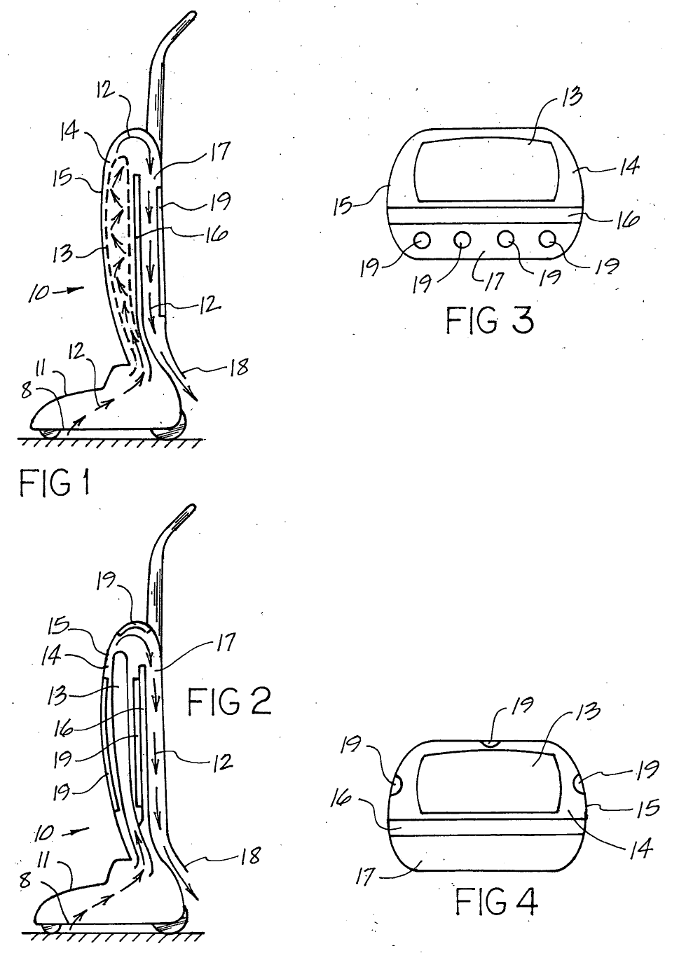

In some typical bag type vacuum cleaners, only a first chamber 14 is provided, and a second chamber 17 is not provided. It should be understood that the second chamber 17, as shown in FIGS. 1-4 are not a requirement for this invention to operate properly. As FIGS. 2 and 4 show, the first chamber 14 housing bag 13. Uv light sources 19 are provided within the first chamber 14, and may be arranged around the periphery of the bag 13, so as to irradiate air that is moving out of the bag 13. In situations where there is no second chamber 17, the air that has been subjected to irradiation may be simply vented as would normally occur.

An improvement on the ability to irradiate air, in an upright vacuum cleaner 10, which uses a bag filtration means, a second chamber 17 is provided. The second chamber 17 is situated adjacent to the first chamber 14, so that when the air pathway 12 exits the first chamber 14, it is directed into the second chamber 17. The first chamber 14 and second chamber 17 are separated by a divider 16, which provides a barrier between the first chamber 14 and second chamber 17 from the bottom portion of the canister 15 up towards the top portion of the canister 15. The barrier 16 does not extend all of the way through the cannister 15, but defines an opening between the first chamber 14 and second chamber 17.

Air moving into the air pathway 12, through the intake port 8, often contains significant amounts of particulate matter. Included in this particular matter are many individual bacteria, that are either attached to other debris, or are free-floating or attached to a very small particulate matter. The bag 13 is unable to contain or restrict certain particulate matter due to its small size. Therefore, when bacteria enters into the bag 13, it has an opportunity to detach from larger debris, and pass through the filtering capabilities of the bag 13, for eventual exit of the vacuum 10 through the discharge port 18.

In the variation of this vacuum system and apparatus 10 as shown in FIGS. 1-4, the second chamber 17 is provided with one or more ultraviolet lights 19, that are powered by the vacuum 10 and emit ultraviolet radiation. Where the second chamber 17 comprises most of the length of the upright canister 15, the second chamber 17 will have a significant amount of time for the filtered air to move along the length of the ultraviolet lighting 19, where the ultraviolet lights 19 comprise long tubes, that are attached to the inner walls of the second chamber 17. These second chamber lights 19 may be mounted in addition to any similar lighting fixed within the first chamber 14, so that the first chamber 14 may have the only ultraviolet lighting sources 19, or the second chamber 17 may have the only ultraviolet lighting sources 19, or both the first chamber 14 and second chamber 17 may have concurrent lighting sources, so as to maximize the available time of irradiation of the air pathway 12.

Filtered air and bacteria moving through the air pathway 12 in the second chamber 17, have significant contact with, and are in close proximity and intensity to the ultraviolet lights 19, so that any bacteria remaining in the air pathway 12 in the second chamber 17 will be sterilized. Therefore, in the embodiment shown in FIG. 1, filtered air that has been subjected to ultraviolet radiation in the second chamber 17, will move out of the vacuum through the discharge opening 18. This treated and irradiated air will have minimal risk of disease to other people in the immediate area, due to the fact that biological substances have been neutralized.

Referring now also to FIG. 3, the bag 13 is shown occupying a portion of the volume defined by the first chamber 14. The first chamber 14 and second chamber 17 are shown separated by a divider 16, which defines a more narrow second chamber 17. The ultraviolet light 19 is shown positioned on the back wall of the second chamber 17 with four light sources 19 being present. This description should in no way be construed to be a limitation on the number of, or positioning of, ultraviolet light 19 sources within a second chamber 17. The arrangement shown in FIG. 3, for the ultraviolet lights 19, allows for a saturation of ultraviolet radiation throughout the second chamber 17, so that the manner in which the bacteria moves through the second chamber 17 will always be adjacent to an ultraviolet light 19. A second chamber 17 may be in any configuration so desired, with one or more ultraviolet lights 19 present along the length of said chamber 17.

Referring now to a second embodiment shown in FIG. 2 and FIG. 4. FIG. 2 shows an upright vacuum cleaner 10, in which the source of ultraviolet light 19 is in the first chamber 14. In such a vacuum 10, the second chamber 17 may or may not even exist. It is not necessary, other than to provide some type of exit port along which the air pathway 12 moves through before leaving through the discharge opening 18. In this embodiment, the ultraviolet light 19 is provided immediately adjacent to the bag 13, where said bag 13 provides the means of filtration or separation of particulate matter from the air moving through the vacuum 10. As FIG. 4 shows, the bag 13 is contained within the first chamber 14 in a manner similar to that shown in FIG. 3. The ultraviolet lights 19 are positioned adjacent to the bag, within the first chamber 14, so that the surface of the bag 13 is subjected to ultraviolet radiation emitted by lights 19. This has the benefit of causing the bag 13 itself to provide an area where bacteria is able to be sterilized as soon as it leaves the bag 13. In the event that ultraviolet radiation proves harmful to the bag 13, causing it to disintegrate or breakdown during its useful life, the first embodiment shown in FIG. 1 and FIG. 3 may be used, since the divider 16 will shield the bag from ultraviolet light radiation. Where this particular embodiment, as shown in FIG. 2 and FIG. 4 is used, the user of the vacuum 10 will be exposed to a minimal amount of bacteria even during the time where the bag 13 is removed for cleaning or disposal.

In both embodiments shown in FIG. 1 and FIG. 3, and that shown in FIG. 2 and FIG. 4, the ultraviolet lighting 19 is powered by the vacuum 10, and is activated when the vacuum 10 is activated. Similarly, the ultraviolet lighting 19 turns off when the vacuum 10 turns off, since there's little need for continued ultraviolet emission, once the air and any bacteria in the air has stopped moving through the air pathway 12.

Referring now to FIG. 5, the typical canister or floor model home vacuum cleaner 20 is shown. This type of vacuum cleaner 20 is also shown in FIGS. 12 and 13. A canister 25 provides the housing and chamber in which the filter bag 23 is positioned. Air is taken in through the hose 21, and enters into the bag 23, which provides the filter barrier for particulate matter present in the air moving into the vacuum 20. In this particular embodiment, the first chamber 24 houses and contains a bag 23. A secondary filter means 26 may be present between the first chamber 24 and discharge opening 28. Where the secondary filter means 26 is present, an ultraviolet light source 29 may be situated between said secondary filter 26 and discharge opening 28, and what is effectively described as a second chamber 27. Ultraviolet lighting 29 is optimally situated within the first chamber 24 so the lighting both illuminates the outer surface of the bag 23 as well as any effective air space located within the first chamber 24. In this manner, the ultraviolet light sources 29 are able to effectively irradiate all air and unfiltered debris that has moved past the bag filter means 23. In this embodiment, the air pathway 22 will be sufficiently irradiated so that by the time it exits through the discharge opening 28, the bacteria within said air stream has been sterilized. Since this vacuum 20, like virtually all household vacuums, causes ejected air to be vented forcefully, it will substantially reduce the risk of disease, or spread of disease, which has its source in the bacteria that is being vacuumed up along with other debris.

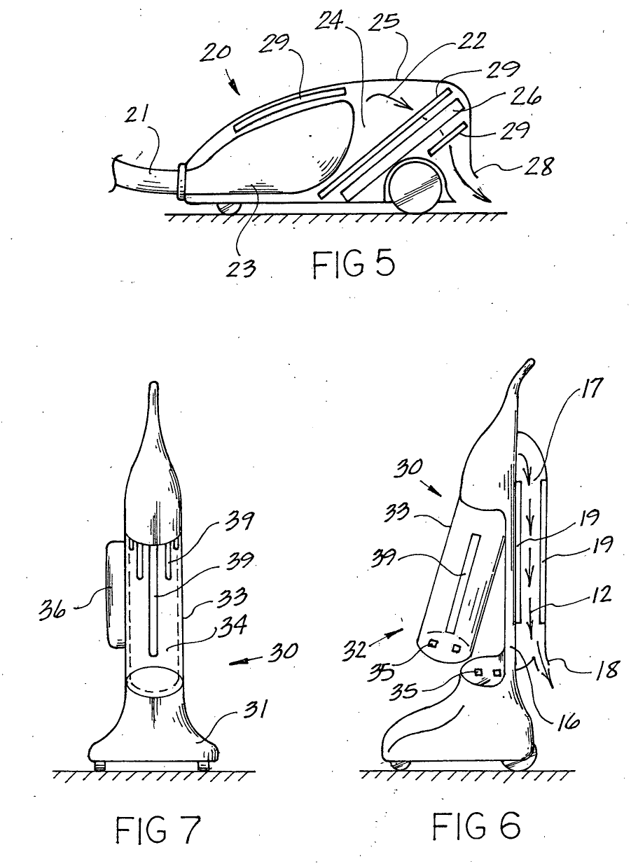

Referring now to FIG. 6 and FIG. 7, a typical upright bagless vacuum 30 is shown. In this type of vacuum 30, the air moving through the vacuum 30 does not enter a bag, but enters into the top area of a removable collector 33, and where the air and debris swirl around in the collector 33 until a significant portion of the debris has settled to the bottom portion of the container 33, which has a closed bottom side. The swirling air, less the heavier debris, is then vented out of the top portion of the container 33 and caused to pass through a filter or what is commonly referred to as a HEPA filter.

This type of filtration allows the heavier particulate matter to be removed when desired from the vacuum 30 itself, by simply removing the collector 33 and dumping out the contents. This dumping process often causes some measure of particulate matter and fine particles to be shaking into the air where they are capable of floating freely. This particular matter will also include bacterial substances. In addition, very small particles are able to escape through the HEPA filter 36, as a result of their small size or as a result of the fact that the filter does not actively prevent 100% of all particles from moving through it.

One manner of allowing the irradiating of all particulate matter and air moving through this vacuum 30 is to provide an ultraviolet light source 39 within the container 33, so that the air and debris circling around it will be exposed to sufficient levels of ultraviolet radiation to sterilize any bacteria contained within the airstream. As is shown in FIG. 6, the light 39 may be a physically integrated into the container 33, where it is positioned and connected to the bottom of the container 33. The light source 39 will project upward in said container 33, being centrally disposed around which air and debris may circle. Metal contacts 35 are provided on the head unit 31, and which are able to contact reciprocal metal contacts 35 on the bottom underside of the container 33. When the container 33 is properly positioned on the vacuum 30 for use, the metal contacts 35 will contact each other causing a circuit to be created, so that when the vacuum 30 is activated, the ultraviolet light 39 will likewise be activated.

As is also shown in FIG. 7, the ultraviolet lighting 39 may be attached to the vacuum itself 39, so that the removable container 33 is positioned around said lighting 39, when the container 33 is properly put in operating position. As is also shown in FIG. 7, multiple ultraviolet lights 39 may be used, with additional light intensity provided at a top area of the open mouth of the container 33, since this is where the air stream both enters and exits the container 33. Where multiple ultraviolet lights 39 are used, they may be of different lengths.

In both embodiments shown in FIG. 6 and in FIG. 7, an ultraviolet light screen 32 or protective coating should be used on the container 33 to protect the user from unwanted ultraviolet radiation emitted within. The ultraviolet light screen 32 is incorporated directly into the sides of the container 33, where said sides of the container 33 are transparent or partially transparent, so that the user is able to ascertain the amount of accumulated debris within the container 33.

As is also shown in FIG. 6, a second chamber 17 is provided with one or more ultraviolet lights 19, that are powered by the vacuum and emit ultraviolet radiation. Where the second chamber 17 comprises most of the length of the upright canister 15, the second chamber 17 will have a significant amount of time for the filtered air to move along the length of the ultraviolet lighting 16, where the ultraviolet lights 16 comprise long tubes, that are attached to the inner walls of the second chamber 17. Filtered air and bacteria moving through the air pathway 12 in the second chamber 17, have significant contact with, and are in close proximity and intensity to the ultraviolet lights 19, so that any bacteria remaining in the air pathway 12 in the second chamber 17 will be sterilized. Therefore, in this embodiment shown in FIG. 6, filtered air that has been subjected to ultraviolet radiation in the second chamber 17, will move out of the vacuum through the discharge opening 18, or whatever additional filter means is used. This treated and irradiated air will have minimal risk of disease to other people in the immediate area, due to the fact that biological substances have been neutralized.

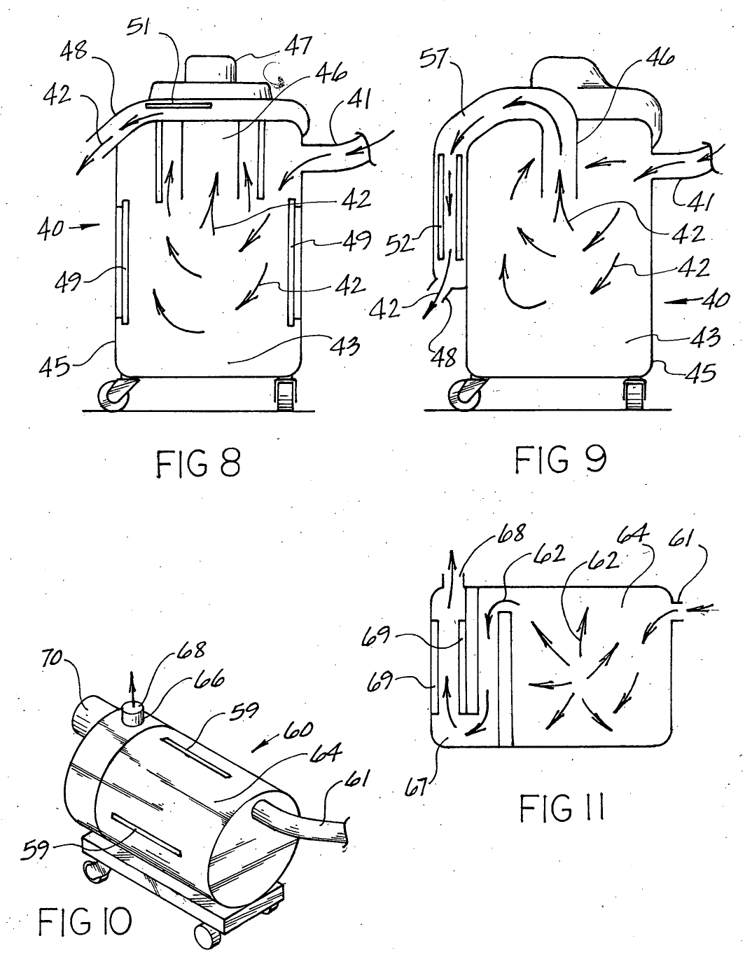

Referring now to FIG. 8 and FIG. 9, what is commonly known as a “shop vac” is shown, in which a bucket shaped canister 45 is provided, that defines an intake port that is connected to a hose 41. A motor that is generally located at the top of this vacuum 40 removes air from the interior of the canister 45 out through a discharge opening 47 that is located on top of the vacuum 40, or through a side discharge 48. These type of vacuums 40 are used to take up substantial debris or even water. Their main purpose is often to simply remove large items of debris. This same concept is used in typical canister vacuums at carwashes.

Generally, some type of filter 46 is present near the top lid of the vacuum 40, but this type of filter 46 is useful only to trap residual debris. The operation of this type of vacuum 40 is accomplished by pumping air out of the canister 45, which causes air to rush in through the hose 41. Since the hose 41 directs air into the canister 45 near the top portion of the canister 45, the heavy debris and particulate matter will swirl around in a circular manner within the canister 45, causing the heavier debris and particles to fall to the bottom where this material collects until emptied. The remaining swirling air and finer particles are discharged out of the vacuum 40.

It is possible to take advantage of the time that the air and particles are swirling within the canister 45, and by situating ultraviolet light sources 49 within the canister 45 adjacent to the air pathway 42 as it circles around inside the canister 45. In addition, ultraviolet light sources 49 may also be positioned immediately adjacent to the filter 46, and may encircle the filter 46 at defined intervals, so as to properly irradiated the entire surface of the filter 46. In this embodiment, it should be understood that the ultraviolet light sources 49 may be used in the lower part of the canister 45, or surrounding the filter 46, or both positions concurrently.

As is also shown in FIG. 8, where a side discharge 48 is used, an ultraviolet light source 51 may be situated within the side discharge 48 pathway, so as to irradiate the airstream 42 as it moves through the side discharge 48. This light may be used singularly, or in conjunction with ultraviolet light sources 49 as indicated above in the cannister 45.

Referring also to FIG. 9, this is the same shop vacuum 40 as shown in FIG. 8, with the addition of a side discharge that has a discharge opening 48 located near the ground. The side discharge allows for a second chamber 57, where the second chamber 57 has one or more ultraviolet lights 52 situated along the length of the second chamber 57, and which are parallel in direction to the air pathway 43 passing through said second chamber 57. The configuration of the second chamber 57 should be considered as illustrative only. The discharge opening 48 may be located at any height desired by the manufacturer or user. Since the air is moving faster through the second chamber 57, than it was in the canister 45, a higher level of ultraviolet light will be needed, and therefore multiple light sources 52 are desirable to achieve the necessary sterilization of bacteria.

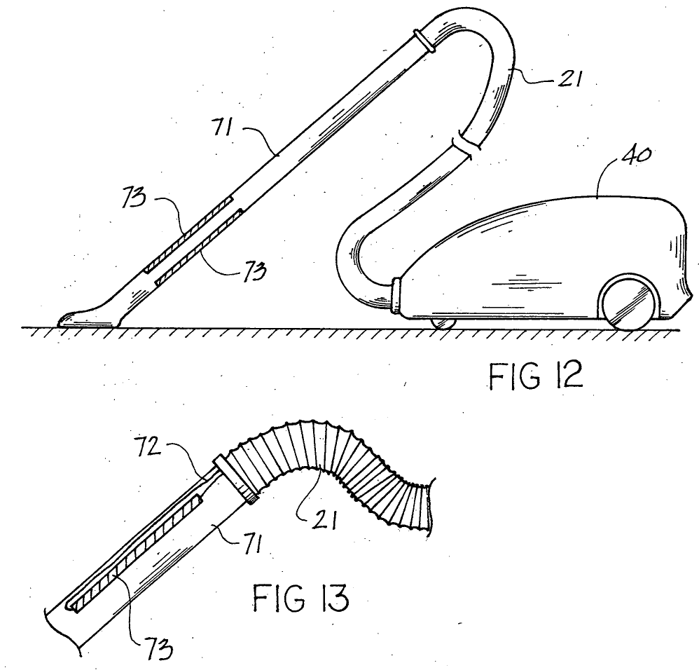

A larger version of the “shop vac” shown in FIG. 8 and FIG. 9 is depicted in FIG. 10 and FIG. 11, in which a tank vacuum 60 is comprised of a large first chamber 64, and a second chamber 67, that are partially separated by a divider 66, that allows air and debris moving in through the hose 61 to swirl about within the tank first chamber 64, which allows the heavier debris and particulate matter to sell to the bottom of the first chamber 64, while the air pathway 62 moves in various directions within the first chamber 64, and then when the air pathway 62 moves over the divider 66 and into a second chamber 67, multiple ultraviolet light sources 69 are situated along the walls of the second chamber 67, and are able to successfully to radiate the air pathway 62 to the second chamber 67 so as to sterilize bacteria.

As is shown in FIG. 10, ultraviolet lights 59 may be placed within the first chamber 64 of the tank vacuum 60. These may be used alone, or in conjunction with the ultraviolet lights 69 in the second chamber. Further, in situations where complete irradiation is required, a baffled second chamber 67 may be utilized. This is accomplished by creating a convoluted air pathway 62, by using two or more dividers, which provide barriers to the air pathway 62, requiring the air pathway 62 to move around the barriers and thus lengthen the time that the air in the air pathway 62 in is the second chamber 67. As is shown in FIG. 11, the first divider is attached at the bottom of the tank in the first chamber 64, and defines one of the walls of the first chamber 64. A second divider 66′ descends from the top of the vacuum 60, and which causes the air pathway 62 to double in overall length within the second chamber 67. Using one or more second dividers 66′, will cause additional air pathway length within the second chamber 67, and therefore numerous ultraviolet light sources 69 may be utilized along the entire length of the air pathway 62, so as to provide complete irradiation for all bacterial matter.

The convoluted air pathway described above for the tank vacuum 60 should be understood as a viable feature to be used with the upright vacuum 10 as shown in FIG. 1 through FIG. 4. Additional dividers and partitions may be used with the upright vacuum 10 to increase the air pathway link within the second chamber 17. Therefore, FIG. 10, showing the second chamber 67, is illustrative of using multiple dividers 66 and 66′ in like manner in other second chambers as shown and described above.

Referring also to FIG. 12, the floor unit vacuum 20, as described previously in FIG. 5, is shown with a complete hose 21 and metal extension tubing 71. The ultraviolet light sources 73, as shown in FIG. 12, are situated along the length of extension tubing 71. The ultraviolet lights 73 are not capable of bending, and are therefore best situated within rigid metal extension tubing 71, which is common on most vacuum systems. Where metal is not used as a material, any rigid tubing that is capable of withstanding ultraviolet light radiation is suitable. This tubing 71 comprises the intake area for this type of vacuum 40, and the tubing 71 provides a chamber, in which the air and debris are able to be treated prior to entering into the main filtration area, comprising a bag, bagless chamber or other filtration collection means. As FIG. 13 more closely shows, the ultraviolet light source 73 is attached to the rigid tubing inner side wall, and electrical wires supplying power travel down the flexible hose 21 from the vacuum electrical source, to power the ultraviolet light source 73. Although FIG. 12 shows the general relationship and position of the ultra violet light sources 73, the placement of ultraviolet light sources 73 with a rigid tubing should not be construed to be limited to the type of vacuum shown in FIG. 12. Any tubing that has a rigid extension 71, is suitable for this placement of ultraviolet light sources. This provides optimal irradiation, since the entire volume of the airstream entering into the vacuum being used is sanitized. Again, one of the drawbacks is that the speed of the airflow may be such that proper sanitation is not accomplished due to the fact that insufficient exposure to ultraviolet light takes place. However, since the airflow is so close to the ultraviolet light sources, less time is necessary to irradiate and sanitize bacterial substance.

It should be understood that any and all combinations of the placement of ultraviolet light sources in a vacuum cleaner as described above may be used alone, or in conjunction with any other combination of ultraviolet light source placement, be it in the tubing extension, a first chamber or collection area, any type of secondary chamber, or any convoluted pathway through which airflow travels in a secondary chamber.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

I claim:

1. A vacuum cleaner, capable of sterilizing biological contaminants in the airstream moving through said vacuum, comprising:
a: an intake port and a discharge opening, where air and debris are received into the vacuum cleaner and follows an air pathway from the intake port to the discharge opening;
b. at least one ultraviolet light, disposed within the vacuum cleaner, where said light is capable of emitting ultraviolet radiation, and where said radiation is able to contact the moving air and debris in the air pathway as the air and debris moves through the vacuum cleaner, with the ultra violet radiation neutralizing bacterial impurities within the air stream.

2. A vacuum cleaner, capable of sterilizing contaminants in the airstream moving through said vacuum, as recited in claim 1, in which the vacuum cleaner comprises a bag vacuum style cleaner, where the ultraviolet light is disposed within the area that houses the bag, with the ultraviolet light emitting radiation that contacts air and debris after it moves through the bag.

3. A vacuum cleaner, capable of sterilizing contaminants in the airstream moving through said vacuum, as recited in claim 1, in which the vacuum cleaner comprises a bag vacuum style cleaner, where multiple ultraviolet lights are disposed within the area that houses the bag, with the ultraviolet lights emitting radiation that contacts air and debris after it moves through the bag.

4. A vacuum cleaner, capable of sterilizing contaminants in the airstream moving through said vacuum, as recited in claim 1, in which the vacuum cleaner comprises a bag vacuum style cleaner, and where a first chamber houses the filter bag, and where a second chamber has at least one ultraviolet light disposed within the second chamber, where the air and debris moving through the vacuum move through the second chamber with emitted radiation from the light making contact with the air and debris in the second chamber.

5. A vacuum cleaner, capable of sterilizing contaminants in the airstream moving through said vacuum, as recited in claim 1, in which the vacuum cleaner comprises a bag vacuum style cleaner, and where a first chamber houses the filter bag, and at least one ultraviolet light is disposed within the first chamber, that emits radiation that contacts air and debris after they have passed through the filter bag, and where a second chamber has at least one ultraviolet light disposed within the second chamber, where the air and debris moving through the vacuum move through the second chamber with emitted radiation from the light making contact with the air and debris in the second chamber.

6. A vacuum cleaner, capable of sterilizing contaminants the airstream moving through said vacuum, as recited in claim 1, in which the vacuum cleaner comprises a bag vacuum style cleaner, and where a first chamber houses the filter bag, and more than one ultraviolet light is disposed within the first chamber, where said lights emit radiation that contacts air and debris after they have passed through the filter bag, and where a second chamber has multiple ultraviolet lights disposed within the second chamber, where the air and debris moving through the vacuum move through the second chamber with emitted radiation from the light making contact with the air and debris in the second chamber.

7. A bagless type vacuum cleaner, capable of sterilizing contaminants in the airstream moving through said vacuum, comprising:
a: an intake port and a discharge opening, where air and debris are received into the vacuum cleaner and follows an air pathway into a collection container, prior to the air stream moving to the discharge opening;
b. at least one ultraviolet light, disposed within the collection container, where said light is capable of emitting ultraviolet radiation, and where said radiation is able to contact the moving air and debris in the air pathway as the air and debris moves within the collection container, with the ultra violet radiation neutralizing bacterial impurities within the air stream.

8. A vacuum cleaner, capable of sterilizing contaminants in the airstream moving through said vacuum, as recited in claim 7, in which at least one ultraviolet light is disposed within said container, and where the light is fixed within the container, with the ultraviolet light emitting radiation that contacts air and debris while it is moving within the container.

9. A vacuum cleaner, capable of sterilizing contaminants in the airstream moving through said vacuum, as recited in claim 7, in which at least one ultraviolet light is disposed within said container, and where the container defines electrical contacts that are capable of receiving electric current for an ultraviolet light fixed within the container.

10. A vacuum cleaner, capable of sterilizing contaminants in the airstream moving through said vacuum, as recited in claim 7, in which multiple ultraviolet lights are disposed within the container, with the ultraviolet lights emitting radiation that contact air and debris while it is in the container.

11. A vacuum cleaner, capable of sterilizing contaminants in the airstream moving through said vacuum, as recited in claim 7, in which at least one ultraviolet light is fixed to the vacuum body, with said lights being disposed within the container when the container is in proper position for use with the vacuum cleaner, and where the emitted ultraviolet light is able to contact air and debris moving in the container.

12. A vacuum cleaner, capable of sterilizing contaminants in the airstream moving through said vacuum, as recited in claim 7, in which multiple ultraviolet lights are disposed within the container, and where the lights are of different sizes so as to provide greater intensity of ultraviolet emissions toward the mouth of the container.

13. A vacuum cleaner, capable of sterilizing contaminants in the airstream moving through said vacuum, as recited in claim 7, in which the vacuum cleaner has a collection chamber, and further defines a secondary chamber, where air and debris move out of the container in the to second chamber prior to exiting the vacuum cleaner, and where the second chamber has at least one ultraviolet light disposed within the second chamber, where the air and debris moving through said second chamber are exposed to the light's emitted radiation.

14. A vacuum cleaner, capable of sterilizing contaminants in the airstream moving through said vacuum, as recited in claim 7, in which the vacuum cleaner has a collection chamber, and where said collection chamber has shielding on the container walls that prevents an undesirable level of ultraviolet light from being emitted from the vacuum cleaner during use.

15. A shop vac type vacuum cleaner, capable of sterilizing contaminants in the airstream moving through said vacuum, comprising:
a: an intake port and a discharge opening, where air and debris are received into the vacuum cleaner and follows an air pathway into a collection container, prior to the air stream moving to the discharge opening;
b. at least one ultraviolet light, disposed within the collection container, where said light is capable of emitting ultraviolet radiation, and where said radiation is able to contact the moving air and debris in the air pathway as the air and debris moves within the collection container, with the ultra violet radiation neutralizing bacterial impurities within the air stream.

16. A vacuum cleaner, capable of sterilizing contaminants in the airstream moving through said vacuum, as recited in claim 15, in which multiple ultraviolet lights are disposed within said container, with the ultraviolet light emitting radiation that contacts air and debris while it is moving within the container.

17. A vacuum cleaner, capable of sterilizing contaminants in the airstream moving through said vacuum, as recited in claim 15, a second chamber is provided, external to the first collection chamber, and where at least one ultraviolet light is disposed within said second chamber.

18. A vacuum cleaner, capable of sterilizing contaminants in the airstream moving through said vacuum, as recited in claim 15, in which the vacuum cleaner further comprises at least one ultraviolet light disposed within the first collection chamber, and also at least one ultraviolet light disposed within the second chamber, where the air and debris moving through the vacuum move through the collection chamber and second chamber with emitted radiation from the lights making contact with the air and debris in both the first and the second chamber.

19. A method of sanitizing bacterial matter within the moving air and debris within a vacuum cleaner, comprising the steps of:
a. receiving air and debris within the air into a vacuum cleaner, where the air and debris constitute and follow an air pathway;
b. passing the moving air and debris in close proximity to an ultraviolet light source, contained within the vacuum cleaner, so that the emitted ultraviolet radiation is able to contact the air and debris as it moves through the vacuum cleaner;
c. venting the air and debris that have been contacted by the ultraviolet radiation.

20. A method of sanitizing bacterial matter within the moving air and debris within a vacuum cleaner, as recited in claim 19, further comprising the step of allowing the air and debris within the air pathway to move into a first chamber where larger debris is collected, and then allowing the remaining air and debris to move into a second chamber where the moving air and remaining debris are exposed to ultraviolet radiation prior to being vented.
